(19) United States
(12) Patent Application Publication
(10) Pub. No.: US 2002/0033974 A1
(43) Pub. Date: Mar. 21, 2002

(54) Input apparatus and method of scanners having composite buttons for enabling functions

(76) Inventors: Frank Chen, Taichung (TW); Cathy Liu, Hsinchu (TW)

Correspondence Address: BACON & THOMAS, 625 Slaters Lane - 4th Floor, Alexandria, VA, 22314-1176, US

(21) Appl. No.: 09/799,538

(22) Filed: Mar. 7, 2001

(30) Foreign Application Priority Data
Sep. 16, 2000 (TW) 89119046

(51) Int. Cl. H04N 1/04; H04N 1/46

(52) U.S. Cl. 358/474; 358/505

(57) ABSTRACT

An input apparatus and method for a scanner that mounts at least one composite buttons is disclosed. A computer system coupled with the scanner shows a graphic interface according to indications of a button pressed by individual for notifying following functions that are going to perform. Individual may enable required functions via associated graphic interfaces to activate copying scanned images, faxing the scanned images to indicated destinations, uploading the scanned images to indicated web sites, or e-mailing the scanned images to addresses indicated by individual.

### BACKGROUND OF THE INVENTION

1. Field of the Invention

The present invention relates to an input apparatus and method having a composite button being capable of enabling a plurality of functions in a scanner. More particularly, the present invention relates to an input apparatus and method in a scanner that provides at least one composite button accompanied with friendly graphic interfaces to facilitate individual to intuitionally enable functions such as scanning or activating associated applications for editing scanned images.

2. Description of the Prior Art

Advancement in electrical engineering makes the functions and performance provided by computer peripheral devices to keep increasing exponentially. For example, engineers who are skilled in manufacturing scanners should unceasingly upgrade scan resolutions and color display performance, they should have to enable their scanners to activate printers to copy scanned images, or to fax the scanned ones to destinations indicated by individual via computer systems. However, conventional scanners usually define a button as a unique function for respectively enabling scanning, copying, or faxing, while individual may activate those functions by pressing associated buttons.

Conventionally, individual should turn on scanner power and make the scanner to successfully connect with a computer system before enabling scan operation by pressing a pre-defined scan button in the scanner or via graphic interfaces provided by scanner manufacturers displayed in the screen of the computer system. Scanned images should be forwarded to the computer system via a connection, therefore individual may perform further operations such as optical character recognition, activating applications for editing scanned images, or even activating a browser to upload the scanned images to web sites indicated by individual. Individual obviously has to complete the scan operation and forward the scanned images to the computer system before performing those further operations. He or she therefore has to search required functions in the interfaces provided by the scanner manufacturers. For those persons who are unfamiliar with computer systems, they usually confuse by powerful interfaces and find no way to obtain entrances for enabling required operations. There is a need to disclose a more convenient operation way accompanied with friendly interfaces that the aforementioned disadvantages of the conventional approaches should be completely eliminated.

### SUMMARY OF THE INVENTION

The principal object of the invention is the provision of an input apparatus and method for a scanner that provides only few buttons accompanied with friendly graphic interfaces to facilitate individual to intuitionally enable functions such as scanning and activating associated applications for editing scanned images.

The other object of the invention is the provision of an input apparatus and method for a scanner that completes associated scan operation, uploading scanned images to those indicated web sites, or activating associated applications for editing information provided by the scanned images via one touch action in the scanner.

In one embodiment, a graphic interface indicative of the function activated by a button of a scanner will be shown to notify individual after the button being pressed, wherein the pressed button may be defined as a composite button for further enabling a plurality of functions. Individual may activate a required function provided by the graphic interface so that the computer system coupled with the scanner will perform operations such as scanning, copying, faxing, uploading to those indicated web sites, or e-mailing to indicated addresses by means of one touch action in scanner side.

In the embodiment, a scan resident module is mounted in the computer system, which further includes a command interpretation module, a command-encoding module, a user interface resource module, a computer resource inquisition module, an Internet resource store and control module, and a connection status detection module. Command interpretation module stores programs operated by the processing device of the computer system to perform operations of interpreting commands input from the scanner or computer system. Command-encoding module stores programs operated by the processing device of the computer system to perform operations of encoding commands for further forwarding to the scanner to enable associated scan operation, or to transfer the scanned image to the computer system. User interface resource module stores resource codes associated with graphics or icons required by the graphic interfaces. Computer resource inquisition module stores programs operated by the processing device of the computer system to perform the operation such as inquiring the currently mounted applications of the computer system. Internet resource store and control module stores codes associated with web sites indicated by individual. Connection status detection module stores programs operated by the processing device of the computer system to perform operation such as monitoring the connection status between the scanner and computer system. Associated operations will be performed when the processing device of the computer system operates the programs or codes provided by the aforementioned modules.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic diagram of the preferred embodiment according to the present invention;

FIG. 1B is an exemplary diagram for illustrating the input device of the scanner in the embodiment;

FIG. 2 is a configuration module of the scan resident module in the embodiment;

FIG. 3A is a diagram illustrating an exemplary graphic interface when individual enables associated scan operation in the embodiment;

FIG. 3B is a diagram illustrating an exemplary graphic interface when individual enables the fax operation in the embodiment;

FIG. 3C is a diagram illustrating an exemplary graphic interface when individual enables the composite button for activating functions included inside according to the embodiment; and

FIG. 4 is a flowchart for illustrating the operating sequences according to the embodiment.

### DESCRIPTION OF THE PREFERRED EMBODIMENT

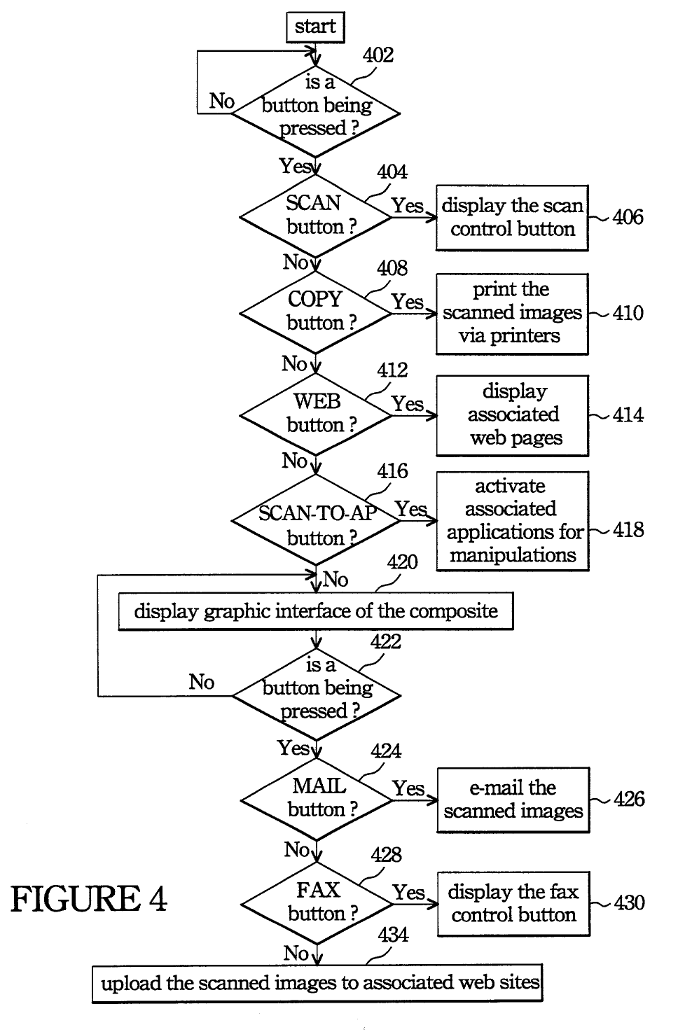

Please firstly refer to FIG. 4, a flowchart illustrative of the operating sequences of the embodiment is disclosed. An example that a scanner includes a scan button (SCAN), a fax button (FAX), a composite button (FCN), an Internet connection button (WEB), and a button for scan and then activating associated application (SCAN-TO-AP) is given for description purpose. The FCN button may be employed to enable the operation of mailing or copying scanned images, or uploading the scanned images to indicated web sites (SCAN-TO-WEB). However, the aforementioned buttons associated with their functions are only example for explanation purpose. Any similar arrangement, such as varying the functions enabling by the composite button, defining several buttons to be composite buttons, varying the function quantities included in a composite button, or increasing/decreasing buttons employed in scanners, within the spirit of the embodiment should be included in the appended claims.

When a button of the scanner being pressed (step 402), a scan control button will be shown in a display of the computer system by means of graphic interfaces to wait for further indications such as confirming or canceling scan operation if the pressed button is the SCAN button from individual (via steps 402, 404, to 406). If the pressed button is the COPY button, then graphic interfaces associated with the COPY button is shown in the display of the computer system to wait for further indications such as confirming or canceling printing operations (via steps 402, 404, 408, to 410). If the pressed button is WEB button, then graphic interfaces associated with the WEB button is shown in the computer system to wait for further indications, e.g., establishing connections, varying URL (Universal resource locator) of a web server, or canceling connections (via steps 402, 404, 408, 412, to 414). If the pressed button is the SCAN-TO-AP button, then graphic interfaces associated with the SCAN-TO-AP button is shown to wait for further indication such as confirming or canceling SCAN-TO-AP operation or selecting a currently activating application (via steps 402, 404, 408, 412, 416 to 418). As noted, the aforementioned buttons follow so-called “one touch” mechanism or action in scanner side and then wait for further indications, e.g., inputting commands for activating scan operation via the input device of the computer system.

Furthermore, if the FCN button is the pressed one, then graphic interface associated with the FCN button will be shown for illustrating functions provided by the FCN button and wait for further indications (via steps 402, 404, 408, 412, 416 to 420). When individual presses the MAIL button in the graphic interface, the computer system transfers scanned images to those indicated e-mail addresses after the scanner completes relative scan operation (via steps 422, 424, to 426). If individual presses the FAX button, the computer system faxes the scanned images to those indicated destinations after the scanner completes the scan operation (via steps 422, 424, 428 to 430). When individual presses the SCAN-TO-WEB button, the computer system uploads the scanned images to those indicated web sites after the scanner completes the scan operation (via steps 422, 424, 428 to 434). As noted, an optical character recognition (OCR) performed by means of associated OCR module is required if selected application (e.g., Word) is a text editor. An ordinary person who is skilled in the art associated with the invention should modify the embodiment as applications, but all the similar arrangement or modifications within the spirit of the embodiment should be included in the appended claims.

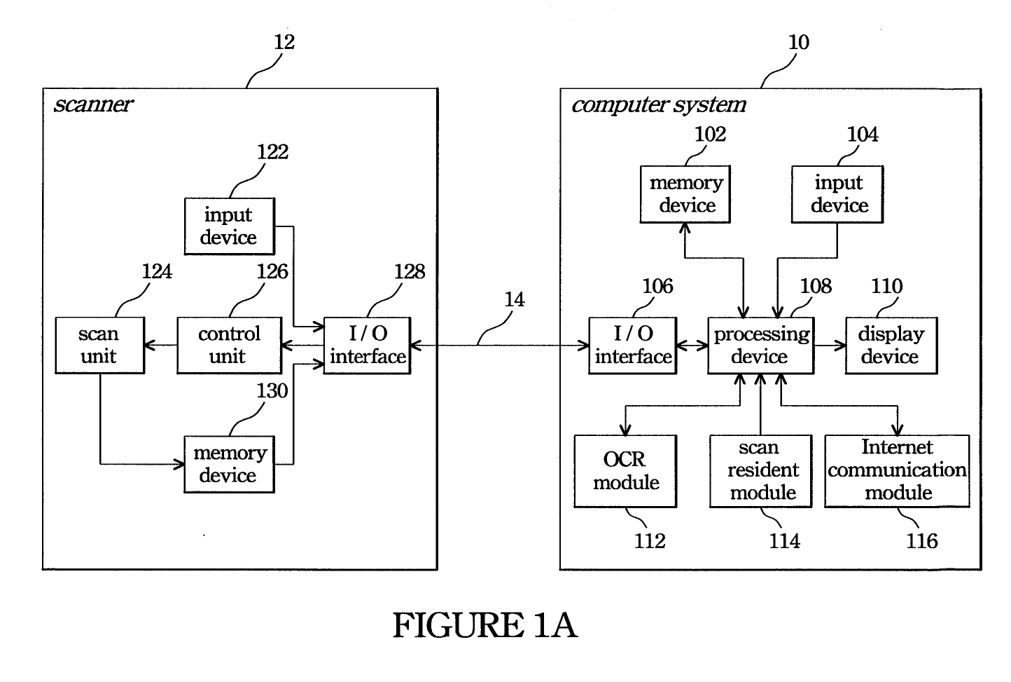

Please next refer to FIG. 1A, a schematic diagram of the embodiment is shown therein, which basically encompasses computer system 10 and scanner 12 that are coupled together via connection 14. Any wireless or wired communication approach or interface, including TWAIN, SCSI, EPP, or USB (Universal serial bus) may be employed as connection 14 in the embodiment. Please note that computer system 10 may be a personal computer (PC), a workstation, a notebook, or even a palm PC, while scanner 12 may be a roller feeding or flatbed scanner.

Computer system 10 in the embodiment basically encompasses memory device 102, input device 104, I/O interface 106, processing device 108, display device 110, OCR module 112, scan resident module 114, and Internet communication module 116. Processing device 108 couples with memory device 102, input device 104, I/O interface 106, display device 110, OCR module 112, scan resident module 114, and Internet communication module 116 to perform required operations of computer system 10 in the embodiment. Input device 104 and display device 110 are both user interfaces that receives commands from individual and displays information by using optical signals, respectively. Memory device 102 stores information of computer system 10 that is provided for further manipulations by processing device 108. I/O interface 106 couples with scanner 12 for forwarding signals required by scanner 12 or for receiving signals input by individual from the scanner 12 that the signals from scanner 12 are routed to processing device 108 for further processing. OCR module 112 stores programs operated by processing device 108 to perform optical character recognition to the scanned images. Scan resident module 114 stores programs permanent stored in computer system 10 for detecting connection status between computer system 10 and scanner 12, interpreting commands from scanner 12, and real-time displaying interpretation results in display device 110 (more detailed explanations are given for scan resident module 114 later). Internet communication module 116 controls required communications with the Internet such as inputting commands for inquiry information or web sites, or downloading/uploading information.

In the embodiment, scanner 12 basically encompasses input device 122, scan unit 124, control unit 126, I/O interface 128, and memory device 130. Input device 122 receives commands input by individual from scanner 12, while I/O interface 128 couples with I/O interface 106 of computer system 10 for transferring signals mutually. Scan unit 124 is responsive to commands from control unit 126, while the generated scanned image is stored in memory device 130 before forwarding via I/O interface 128, connection 14 to computer system 10 to wait for manipulations by processing device 108.

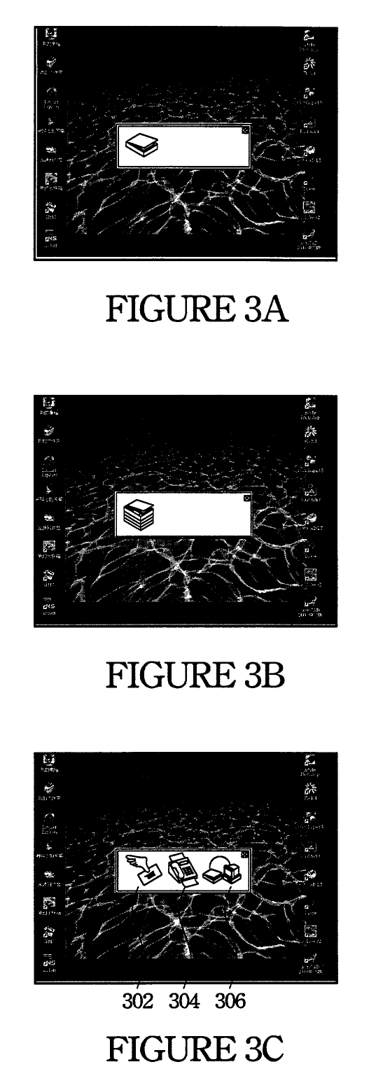

Input device 122 may be provided as interfaces for receiving commands by employing the configuration in FIG. 1B, which encompasses a scan button (SCAN) 142, a copy button (COPY) 144, a composite button (FCN) 146, an Internet communication button (WEB) 148, and a button for scan and then activating associated applications (SCAN-TO-AP) 150. In operations, when individual presses SCAN button 142, the signals indicative of the pressing of SCAN button 142 will be routed to computer system 10 for manipulation. A graphic interface shown in FIG. 3A may be employed to notify individual for giving indications such as confirmations for associated scan parameters (e.g., scan resolution) while scanning, or enabling the scan operation via the shown graphic interface. A confirmation command input via the graphic interface (may be input via the same button in scanner 12 by pressing it again) will be forwarded to scanner 12 for scanning document sheets. Additionally, when individual presses COPY button 144, the signals indicative of COPY button 144 being pressed will be routed to computer system 10 for manipulations so that a graphic interface in FIG. 3B may be shown to individual. Scanned images of document sheets are then derived after a confirmation command for copying scanned document sheets being input from individual. Similarly, when individual presses WEB 148, the button pressed signals will be routed to computer system 10 for manipulations. Computer system 10 will connect with indicated web sites before deriving the scanned images for uploading. Additionally, when individual presses FCN button 146, the button pressed signals will be routed to computer system 10 for manipulations. A graphic interface in FIG. 3C including graphic buttons 302, 304, and 306 respectively for activating functions of mailing (MAIL), faxing (FAX), and scanning and then loading by associated applications (SCAN-TO-AP) will be shown in display device 110 of computer system 10.

As noted, when individual selects SCAN-TO-AP button 150, scanner 12 routes the scanned images to computer system 10 after scanning. An associated application, e.g., PaintBrush or Imaging, is then activated to load the scanned images for image editing or processing, while the text editor such as Microsoft Word or Excel may be activated for text editing after the scanned image being converted by employing OCR module 112. Please note that a step of selecting or varying the associated application for manipulations to the scanned images may be used before individual presses SCAN-TO-AP button 150 to activate associated operations. It is obvious that individual may enable required operations by employed so-called “one touch” actions in scanner 12. Furthermore, individual may assign associated parameters of physical or graphic buttons in computer system 10 before activating associated operations so that individual may establish an operating environment suitable for personal usage. Any mechanism for establishing “one touch” action may be employed in the embodiment, the skilled persons may modify the embodiment as applications but all the similar arrangements within the spirits of the embodiment should be included in the appended claims. Additionally, the functions associated with WEB button 148 may refer to the reference application entitled “Apparatus and method for directly uploading scanned images to associated web sites” having the same Applicants with the present invention. However, another invention with the same Applicant entitled “Apparatus and method for directly activating an application for editing information of an image after format conversion” can be a cross-reference article of the invention for giving descriptions to SCAN-TO-AP button 150.

As noted, the aforementioned input device 104 of computer system 10 may be any kind of input interface, such as keyboard, mouse, or track ball, while input device 122 of scanner 12 may encompass at least one button or any mechanism for enabling the “one touch” action. Display device 110 may be a CRT or LCD system in the embodiment. Moreover, processing device 108 may be CPUs or microprocessors broadly employed in modem computer systems, while control unit 126 also can be mounted by means of microprocessors. Memory device 102 or 130 may be mounted by using DRAM, SRAM, or flash memory, etc, while OCR module 112, scan resident module 114, and Internet communication module 116 may be stored in computer-readable storage media such as hard disks. The aforementioned I/O interfaces 106 and 128 may be mounted according to practically employed interface for connection 14, while scan unit 124 may be any mechanism or device for scanning document sheets. An ordinary person skilled in the art of the invention may modify the embodiment as applications.

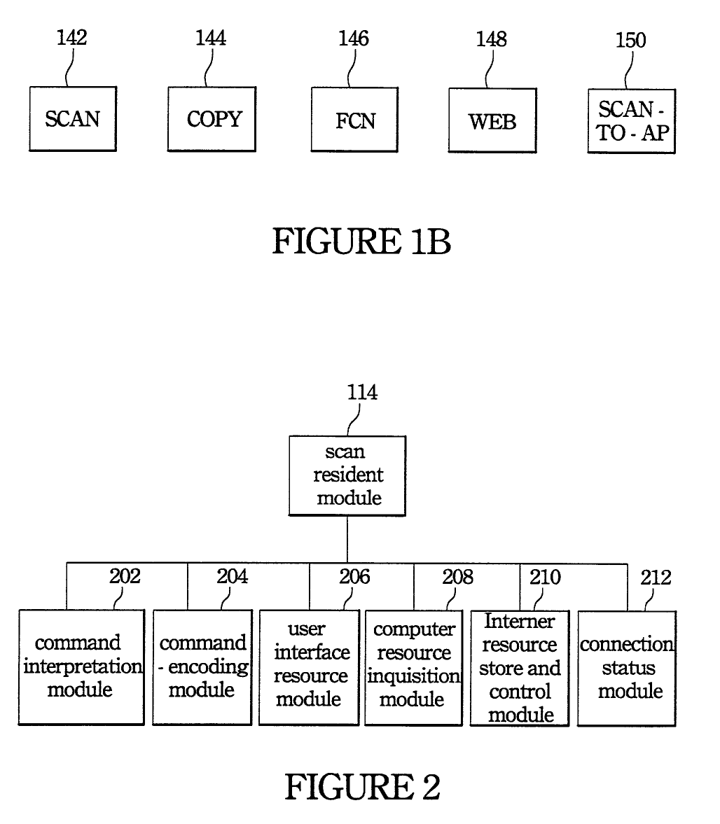

Please next refer to FIG. 2, a detailed configuration illustrative of scan resident module 114 is shown for giving more explanations. Basically, scan resident module 114 encompasses command interpretation module 202, command-encoding module 204, used interface resource module 206, computer resource inquisition module 208, Internet resource store and control module 210, and connection status detection module 212. Command interpretation module 202 stores programs provided for processing device 108 of computer system 10 to perform operations of interpreting commands input from scanner 12 or computer system 10. Command-encoding module 204 stores programs provided for computer system 10 to perform operations of encoding commands in computer system 10 for further forwarding to the scanner to enable scan operation via connection 14, or to transfer the scanned image to computer system 10. User interface resource module 206 stores codes associated with graphics or icons required by the graphic interfaces shown in display device 110. Computer resource inquisition module 208 stores programs provided for computer system 10 to perform operations of inquiring the currently mounted applications of computer system 10. Internet resource store and control module 210 stores codes associated with web sites indicated by individual. Connection status detection module 212 stores programs provided for computer system 10 to perform operations of monitoring connection 14 between the scanner 12 and computer system 10. Associated operations will be performed when processing device 108 of computer system 10 operates programs or codes provided by the aforementioned modules. As noted, the aforementioned modules may be stored in any computer-readable and portable storage medium, e.g., a compact disc (CD), floppy disk, or magnetic optical (MO) disk, which is further accessed and operated by processing device 108. However, the programs or codes of the above modules may be stored in hard disks of the computer system 10 for performing associated operations while scanner 12 activating.

As is understood by a person skilled in the art, the foregoing preferred embodiments of the present invention are illustrated of the present invention rather than limiting of the present invention. It is intended to cover various modifications and similar arrangements e.g., varying functions included in a composite button, mounting more than one composite buttons, or modifications to function quantities of a composite button, included within the spirit and scope of the appended claims, the scope of which should be accorded the broadest interpretation so as to encompass all such modifications and similar structure.

What is claimed is:

1. A scanner having composite input capability, said scanner employing one touch action to receive commands, wherein said scanner comprises:
a scan unit being responsive for scanning a document sheet to generate a scanned image; and
an input device having at least one input mechanism for receiving an activation command, wherein at least one of said input mechanism is responsive to said activation command to enable an interface having said composite input capability for activating more than one functions associated with said scanned image;
wherein said scanned image is forwarded to a computer system coupled with said scanner for perform one of said functions associated with said scanned image according to a confirmation command.

2. The scanner according to claim 1, wherein said input mechanism comprises at least one button.

3. The scanner according to claim 1, wherein said function performed by said computer system to said scanned image comprises an operation of copying said scanned image, faxing said scanned image to an indicated destination, activating said scanner to scan said document sheet for generating said scanned image, uploading said scanned image to an indicated web site, e-mailing said scanned document to an indicated e-mail address, or activating an application for editing information provided by said scanned image.

4. The scanner according to claim 3, further comprising an operation of performing an optical character recognition before activating said application.

5. The scanner according to claim 1, wherein said computer system is responsive to said activation command received by said input mechanism for showing a graphic interface in said computer system for receiving said confirmation command.

6. A method of activating a composite input capability for a scanner, wherein said scanner employs one touch action to receive commands, said method comprising the steps of:
receiving an activation command by means of one touch action from said scanner;
activating a graphic interface according to said activation command, wherein said graphic interface is shown in a computer system coupled with said scanner; and
performing a function to a scanned image generated by said scanner according to an indication of a confirmation command.

7. The method according to claim 6, wherein said scanner comprises a button to receive said activation command from said scanner.

8. The method according to claim 6, wherein said graphic interface comprises at least one input mechanism having said composite input capability.

9. The method according to claim 8, wherein said computer system performs a function indicated by an activated input mechanism.

10. The method according to claim 9, wherein said function performed by said computer system to said scanned image comprises an operation of copying said scanned image, faxing said scanned image, scanning a document sheet to generate said scanned image, uploading said scanned image to an associated web site, e-mailing to an e-mail address, or an operation of activating an application for editing information including in said scanned image.

11. The scanner according to claim 10, further comprising an operation of performing an optical character recognition operation before activating said application.

12. The method according to claim 6, wherein said graphic interface comprises an interface employed for confirming scan parameters for generating said scanned image.

13. The method according to claim 6, wherein said confirmation command is input from said graphic interface or from said scanner.

14. A computer system that controls a scanner having composite input capability that said scanner is driven via one touch action, wherein said computer system comprises:
a storage device; and
a processing device coupled with said storage device for operating programs provided by said storage device to
activate said scanner to generate a scanned image of a document sheet;
display one of graphic interfaces associated with an activation command via said one touch action, wherein at least one of said graphic interfaces having said composite input capability for activating more than one functions associated with said scanned image; and
perform a function indicated by a confirmation command.

15. The computer system according to claim 14, wherein said programs comprises:
a command interpretation module for storing programs operated by said processing device for interpreting said activation command input from said scanner or said computer;
a command-encoding module for storing programs operated by said processing device for encoding said confirmation command, forwarding said encoded confirmation command to said scanner for generating said scanned image, forwarding said scanned image generated by said scanner to said computer system;
a user interface resource module for storing resource codes of said graphic interfaces; and
a computer resource inquisition module for storing programs operated by said processing device for inquiring applications mounted in said computer system.

16. The computer system according to claim 15, further comprising an Internet resource store and control module for storing resource codes of a web site to which said scanned image is uploaded.

17. The computer system according to claim 16, wherein said resource codes provided by said user interface resource module comprises icon resource codes or graphic resource codes of said graphic interfaces.

18. The computer system according to claim 14, wherein said processing device operates said programs provided by said storage device to perform an operation of copying said scanned image, faxing said scanned image, uploading said scanned image to an associated web site, e-mailing to an e-mail address, or activating an application for editing information including in said scanned image.

19. The computer system according to claim 18, wherein said processing device operates said programs provided by said storage device to perform an operation of activating an optical character recognition operation before activating said application.
